(19) United States
(12) Patent Application Publication
(10) Pub. No.: US 2003/0014574 A1
(43) Pub. Date: Jan. 16, 2003

(54) Multiple-channel wireless input unit

(76) Inventors: Shih-Jen Kuo, Taipei (TW); Tsung-Yu Wang, Taipei (TW); Yen-Liang Kuan, Taipei (TW); Victor Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/901,716

(22) Filed: Jul. 11, 2001

(51) Int. Cl. G06F 13/12

(52) U.S. Cl. 710/62

(57) ABSTRACT

The multiple-channel wireless input unit is applied to a computer system that involves the use of wireless peripherals. Each different input device is respectively controlled by a CPU to transmit signals from its transmitter at a different channel, while its receptor controls a CPU that in turn controls a scanning device to scan the input signals at different channels. The signals are then transmitted to the computer through a USP port. The receptor receives signals at different times by scanning operation to achieve the purpose of simultaneous reception of two packets of signals in a time-divided and labor-divided fashion, and upgrade the operational efficiency of the wireless input unit.

### BACKGROUND OF THE INVENTION

1. Field of the Invention

This invention relates to a multiple-channel wireless input unit with industrial applicability, capable of receiving signals at different times by scanning operation of a receptor between USB wireless peripherals and a computer main unit, to achieve the purpose of simultaneous reception of two packets of signals in a time-divided and labor-divided fashion, and upgrade the operational efficiency of the wireless input unit.

2. Background of the Invention

Conventionally, a computer and respective peripherals must be connected by a proper transmission interface and signal cables to perform signal conversion and data transmission. In recent years, however, wireless signal transmitters and receptors are introduced to receive control signals of various wireless peripherals transmitted through a USB signal transmitter, so the respective USB peripheral can control and operate the computer by wireless transmission.

The signal transmission module and signal reception module of wireless peripherals and computer systems generally involve RF modules to transmit and receive the signals. Because more and more wireless peripherals have been used, in case of improper distribution of channels, interference would often be the result. Furthermore, transmission between the wireless peripheral and the computer main unit is maintained by repeated transmission of identification signals from the wireless peripheral at a specified interval of time. But the computer main unit is unable to receive and identify the signals simultaneously transmitted from various wireless peripherals. It often results in failure of the transmitter module, or even adverse effect on the normal operation of its distant-end wake-up function.

### SUMMARY OF THE INVENTION

The primary objective of this invention is to provide a multiple-channel wireless input unit, wherein the receptor in the computer main unit performs scanning operation, between the USB wireless peripheral and the computer main unit, to receive signals at different times, to achieve the purpose of simultaneous reception of two packets of signals without missing any signals, and upgrade the operating efficiency of the wireless input unit.

According to the invention, the multiple-channel wireless input unit is applied to a computer system that involves the use of wireless peripherals. Each different input device is respectively controlled by a CPU to transmit signals from its transmitter at different channels and receive the signals by the receiving end. At the receiving end is a scanning device that is controlled by a CPU. The CPU controls the scanning of input signals at different channels, and then transmits the signals to the computer through a USP port. The scanning device of the receptor receives different signals at different times in its scanning operation to achieve the purpose of time-divided and labor-divided, simultaneous reception of two packets of signals without missing any signals.

Another objective of the invention is to provide a multiple-channel wireless input unit, which involves a receptor's scanning operation between the USB wireless peripherals and the computer main unit, to simultaneously receive signals transmitted from different peripherals in a time-divided and labor-divided fashion, upgrade the efficiency of wireless signal input, and prevent mutual interference between wireless peripherals.

### BRIEF DESCRIPTION OF DRAWING

FIG. 1 is a block diagram of the invention.

### DETAILED DESCRIPTION OF PREFERRED EMBODIMENT

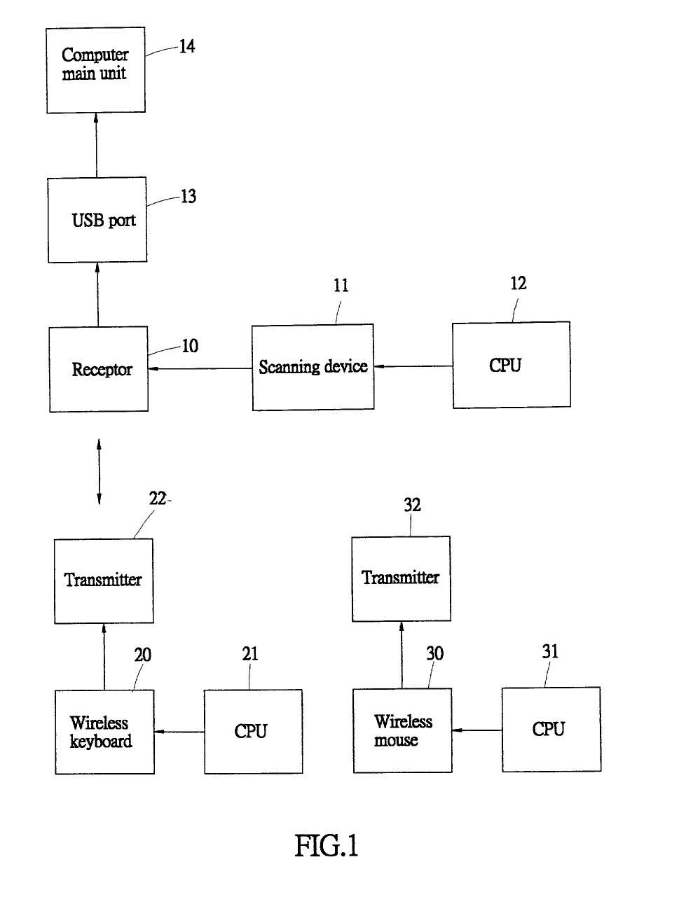

As shown in FIG. 1, the multiple-channel wireless input unit of the invention is applied to a computer system that involves the use of wireless peripherals. The computer system comprises a computer main unit 14 with a receptor 10, and other wireless input devices, including at least a wireless keyboard 20 and a wireless mouse 30.

As shown in FIG. 1, the receptor 10 of the computer main unit 14 has a scanning device 11. This scanning device 11 is controlled by a CPU 12 to receive signals transmitted at different times from different wireless peripherals during its scanning operation.

The wireless keyboard 20 includes a transmitter 22 that is composed of an RF module, and a CPU 21. The CPU 21 serves to control the RF module of the transmitter 22, to transmit control signals of the wireless keyboard 20 to the computer main unit 14 at a different channel.

The wireless mouse 30 includes a transmitter 32 that is composed of an RF module, and a CPU 31, to control the transmitter 32 to transmit control signals of the wireless mouse 30 to the computer main unit 14 at a different channel.

For each different input device, the wireless keyboard 20 or the wireless mouse 30, is respectively controlled by CPU's 21, 31, its RF module transmitting control signals to the computer main unit 14 at different channels. Meanwhile, the receptor 10 of the computer main unit 14 is activated by the scanning device 11, which in turn is controlled by the CPU 12, to receive respective input signals at aforementioned different channels at different times during its scanning operation. The signals are then transmitted to the computer main unit 14 through a USP port 13, thus to achieve the anticipated objective of time-divided and labor-divided reception without missing any signals.

Therefore, the invention of multiple-channel wireless input unit is specially designed for wireless signal transmission between the computer main unit and USB wireless peripherals, the receptor's scanning operation will receive signals at different times to achieve the anticipated objective of time-divided and labor-divided, simultaneous reception of two packets of signals.

Besides, the invention of multiple-channel wireless input unit simultaneously receives signals transmitted from different peripherals in a time-divided and labor-divided way, thereby enhances the efficiency of input and reception of wireless signals, and prevents mutual interference between wireless peripherals, to obtain excellent transmission quality for the transmission and reception of control signals.

What is claimed is:

1. A multiple-channel wireless input unit, applied to a computer system that involves the use of wireless peripherals, comprising a computer main unit having a receptor, and the input devices including at least a wireless keyboard and a wireless mouse, characterized in that:
the wireless keyboard includes a transmitter that is composed of an RF module, and a CPU, said CPU is capable of controlling the transmitter, to transmit control signals of the wireless keyboard to the computer main unit at a different channel;
the wireless mouse includes a transmitter that is composed of an RF module, and a CPU, and is used to control the transmitter to transmit control signals of the wireless mouse to the computer main unit at a different channel; and
the computer main unit has a receptor that includes a scanning device, this scanning device being controlled by a CPU to receive signals transmitted from different wireless peripherals at different times during its scanning operation, the signals then transmitted to the computer main unit through a USP port, to achieve the purpose of time-divided and labor-divided, simultaneous reception of two packets of signals.

2. The multiple-channel wireless input unit as claimed in claim 1, wherein said computer main unit simultaneously receives the signals transmitted by different peripherals in a time-divided and labor-divided fashion.
